(19) United States
(12) Patent Application Publication
(10) Pub. No.: US 2025/0148400 A1
(43) Pub. Date: May 8, 2025

(54) ADMINISTRATIVE MANAGEMENT OF USER ACTIVITY DATA USING GENERATIVE ARTIFICIAL INTELLIGENCE

(71) Applicant: Microsoft Technology Licensing, LLC, Redmond, WA (US)

(72) Inventors: Li MENGKE, Bellevue, WA (US); Qiwen ZHENG, Sammamish, WA (US); Jason Allen HEINTZ, Centennial, CO (US); John Matthew MANGINO, Ellicott City, MD (US); David MINASYAN, Bothell, WA (US)

(73) Assignee: Microsoft Technology Licensing, LLC, Redmond, WA (US)

(21) Appl. No.: 18/502,276

(22) Filed: Nov. 6, 2023

(51) Int. Cl. G06Q 10/0639; G06F 40/40; G06Q 10/10

(52) U.S. Cl. CPC G06Q 10/06398; G06F 40/40; G06Q 10/103

(57) ABSTRACT

A device includes: a processor, and a memory storing executable instructions which, when executed by the processor, causes the processor, alone or in combination with other processors, to provide the following: a user interface comprising administrator access to a collaboration system, the user interface comprising a control to invoke an artificial intelligence (AI) assistant function; and an Application Programming Interface (API) to, in response to activation of the control, download user activity data for the collaboration system, generate a prompt for a Large Language Model (LLM) comprising the user activity data and instructing the LLM to generate a report based on the user activity data, and submit the prompt to the LLM and receive the report generated by the LLM. The user interface provides the report and controls for administrative actions suggested by the report.

### BACKGROUND

With rapid technological advancements and a growing reliance on digital solutions, the need for efficient and streamlined collaboration among the people within an organization has never been greater. To address this demand, applications and services have emerged to facilitate collaboration among the users within an organization.

These applications or services offer organizations a platform on which to create any number of collaboration sites where a group of users are able to create, store, manage, and share a wide array of content and resources. Such a site may serve as the digital nexus for teams, departments, and entire organizations. The communication and connectivity provided by such a site fosters an environment that encourages efficient collaborative efforts. For example, such collaboration sites not only allow for the storage and dissemination of documents but can also facilitate version control and workflow automation.

The operation of these collaboration sites and the realization of their full potential necessitate some administration and oversight. For example, a site administrator may want to determine the number of people who have visited the site, how many times people have visited the site, and a list of files that have received the most views. The site administrator will also want to ensure the security of the site and see that no unauthorized access or sharing of resources is occurring via the site.

The ability to monitor and analyze user interactions within the collaboration environment empowers site administrators with data-driven decision-making capabilities. By gauging the popularity of specific files and assessing site traffic, administrators can tailor their content strategies to better meet the needs and expectations of their users. Moreover, this granular level of oversight allows for a more strategic allocation of resources, ensuring that the collaboration site remains a dynamic and efficient hub for teamwork and information exchange.

However, as the number of users and the traffic on a collaboration site increases, the volume of data available to an administrator may become overwhelming. This may rise to the level of preventing the administrator from effectively understanding what is happening on the site because the activity reporting is too voluminous. This presents a technical problem that prevents the administrator from effectively monitoring the operation and activity on the site.

### SUMMARY

In one general aspect, the following description presents a device that includes: a processor, and a memory storing executable instructions which, when executed by the processor, causes the processor, alone or in combination with other processors, to provide the following: a user interface comprising administrator access to a collaboration system, the user interface comprising a control to invoke an artificial intelligence (AI) assistant function; and an Application Programming Interface (API) to, in response to activation of the control, download user activity data for the collaboration system, generate a prompt for a Large Language Model (LLM), the prompt comprising the user activity data and instructing the LLM to generate a report based on the user activity data, and submit the prompt to the LLM and receive the report generated by the LLM. The user interface provides the report and controls for administrative actions suggested by the report.

In another general aspect, the following description presents a method of administering a collaboration system that includes: in response to activation of a control to invoke an artificial intelligence (AI) assistant function in an administrator portal of the collaboration system, downloading a volume of user activity data for the collaboration system; with an Application Programming Interface (API) generating a prompt for a Large Language Model (LLM), the prompt comprising the user activity data and instructing the LLM to generate a report based on the user activity data; and submitting the prompt to the LLM and receiving the report generated by the LLM. The report summarizes insights based on the volume of user activity data and recommended administrative actions corresponding to the insights, the administrator portal providing controls for the administrative actions recommended by the report.

In another general aspect, the following description presents a device that includes a processor, and a memory storing executable instructions which, when executed by the processor, causes the processor, alone or in combination with other processors, to perform the following functions: downloading a volume of user activity data for a collaboration system; with an Application Programming Interface (API), generate a prompt for a Large Language Model (LLM) comprising the user activity data and instructing the LLM to generate a report based on the user activity data; and submit the prompt to the LLM and receive the report generated by the LLM. The report summarizes insights based on the volume of user activity data and recommended administrative actions corresponding to the insights, the administrator portal providing controls for the administrative actions recommended by the report.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system for generating specific insights from a quantity of administrative data upon which aspects of this disclosure may be implemented.

FIG. 2 depicts an example user interface for a system according to the principles described herein.

FIG. 3 depicts a flow chart for a method for generating specific insights from a quantity of administrative data according to the principles described herein.

FIG. 4A depicts another example system for generating specific insights from a quantity of administrative data according to the principles described herein.

FIG. 4B is an alternative depiction of an example system for generating specific insights from a quantity of administrative data according to the principles described herein.

FIG. 5 is an alternative depiction of an example system for generating specific insights from a quantity of administrative data according to the principles described herein.

FIG. 6 depicts additional aspects of the user interface of FIG. 2.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

As noted above, as the number of users and the traffic on a collaboration site increases, the volume of data available to an administrator may become overwhelming. This may prevent the administrator from effectively understanding what is happening on the site because the activity reporting is too voluminous. This presents a technical problem that prevents the administrator from effectively monitoring the operation and activity on the site.

Consequently, the following description provides a technical solution to this problem. Specifically, an Artificial Intelligent (AI) assistant is described that is able to process the volume of activity data from a collaboration application or system that an administrator cannot digest in real time. The AI assistant accordingly provides specific insights and needed or recommended actions for the administrator based on the volume of activity data. Thus, the administrator is able to effectively administer activity on the collaboration system in real time despite the volume of activity data being generated.

As used herein, a collaboration system or application refers to an application, a service or combination thereof that provides for collaboration between authorized users including messaging, calendaring, file sharing, workflow management, etc.

As used herein, a Large Language Model (LLM) is a type of artificial intelligence system designed to process and generate human-like text by utilizing advanced natural language processing techniques. LLMs are characterized by their extensive training on vast amounts of text data, enabling them to understand and produce written or spoken language in a contextually coherent and semantically meaningful manner. A specific example of an LLM is the Generative Pretrained Transformer (GPT) of which there have been a series of progressive versions.

As used herein, a “completion API” is a type of application programming interface (API) that is designed to provide suggestions or auto-completion for a particular task, typically in the context of search engines, text input fields, or command-line interfaces. The primary purpose of a completion API is to assist users by predicting and suggesting the completion of a word, phrase, or command as they type or input text. It is a common feature in software applications, web search engines, and various text-based interfaces.

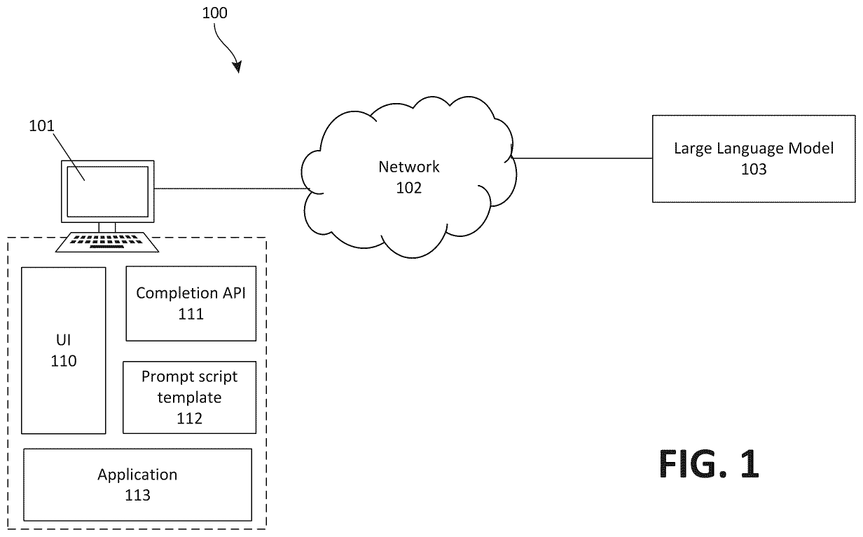

FIG. 1 depicts an example system for generating specific insights from a quantity of administrative data upon which aspects of this disclosure may be implemented. As shown in FIG. 1, an administrator of a collaboration system may be operating a user terminal 101. The user terminal 101 may be any computer device including, for example, a desktop computer, laptop computer, tablet computer, smartphone, personal digital assistant, etc. The user terminal 101 includes a network interface for communication via a computer network 102, for example, the internet, an intranet, or a large or wide area network. The network 102 may be wired, wireless or a combination of both.

As further shown in FIG. 1, the user terminal 101 includes the collaboration application 113 or an administrative portal for the collaboration application. The application 113 presents a user interface 110 with which the administrator can access, use and/or administer the collaboration application or system. As described above, this user interface 110 allows an appropriately credentialled administrator to generate and view activity data for activity on the collaboration system. For example, the administrator may access reports that detail general traffic volume, file sharing activity, messaging or other activity on the collaboration system. As also described above, this activity data can quickly become overwhelmingly large for the administrator. As result, problematic activity that may signal unauthorized activity on the collaboration system or other inappropriate activity may go undetected by the administrator because of being buried in such a large volume of information. Consequently, even though the administrator has full access to the activity data available, the administrator may not be able to effectively administer the organization's priorities and security on the collaboration system.

To solve this technical problem, the user interface 110 includes an option to call the AI assistant described above to assist with management of the activity data available. As will be described in greater detail below, when the administrator invokes the AI assistant using the user interface 110, the application 113 will use a completion Application Programming Interface 111 for the following operations. A volume of the activity data available will be incorporated into a prompt to an LLM. This prompt is engineered using a prompt script template 112 available to the API 111. The prompt script template may be stored locally on the terminal, as shown in FIG. 1 or may be stored remotely and accessible over the network.

As engineered by the API 111, the prompt will instruct an LLM 103 to ingest the appended activity data from the collaboration system and, based on the activity data, generate a concise report listing the principal insights the administrator needs from the volume of activity data. The prompt may also direct the LLM to produce specific recommended actions for the administrator to take based on the identified insights.

The prompt is then submitted via the network 102 to the LLM 103. The LLM 103 will generate the report from the activity data, as instructed, and return the report via the network 102 to the user terminal 101. The report will then be available to the administrator via the user interface 110. The administrator can then apprehend what is occurring in the collaboration system and determine what administrative actions are needed to protect the integrity or security of the organization's collaboration system and data. The user interface 110 or administrator portal also includes controls for the administrator to implement the actions suggested by the report to enhance operation or security of the collaboration system. In some examples, the data used for the prompt is not cached or retained. This may help promote the security of the data defining user activity on the collaboration system.

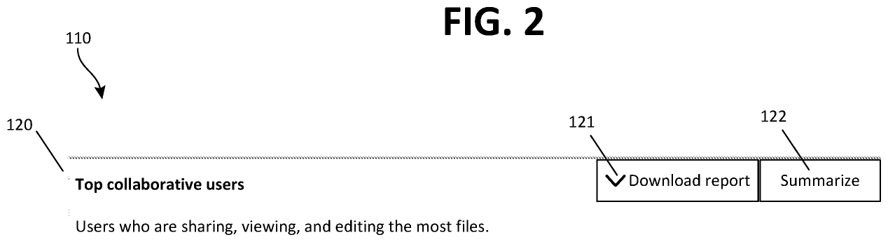

FIG. 2 depicts an example user interface for a system according to the principles described herein. As shown in FIG. 2, an example user interface 110 may have a number of different categories 120 of activity data that can be monitored by the administrator. In the illustrated example, one of the categories 120 is “Top collaborative users” which provides information as to which users are sharing, viewing and editing the most files. Any number of such categories could be listed and available to the administrator.

In connection with the category or categories selected, the user interface 110 includes a “download report” button 121. If the administrator selects this button, a report will be generated and downloaded that lists all the activity information available for the selected category or categories. As noted above, this activity data may be so voluminous as to preclude the administrator from digesting and interpreting the data in real time. In fact, the data may readily be so voluminous that if the administrator does attempt to digest and interpret the data, by the time any insights are produced, those insights are no longer relevant to current activity in the collaboration system.

Accordingly, the user interface 110 also includes a button 122, e.g., a “summarize” button, to invoke the AI assistant features described above. Specifically, when the administrator selects this button 122, the activity data for the selected category or categories is collected and downloaded. The activity data is then appended to an LLM prompt, which will be described in greater detail below. The prompt is then submitted to an LLM, as described above in connection with FIG. 1. The result is a report in real time that provides the administrator with an accurate view of what is happening on the collaboration system and what actions might be needed to better administer the system. Alternatively, collection of the activity data and the prompt to the LLM or a summarization report could be performed automatically, for example, on a periodic basis. In such an example the resulting report could be offered to the administrator when available without the administrator having to initiate the AI assistant feature to produce the report as described herein.

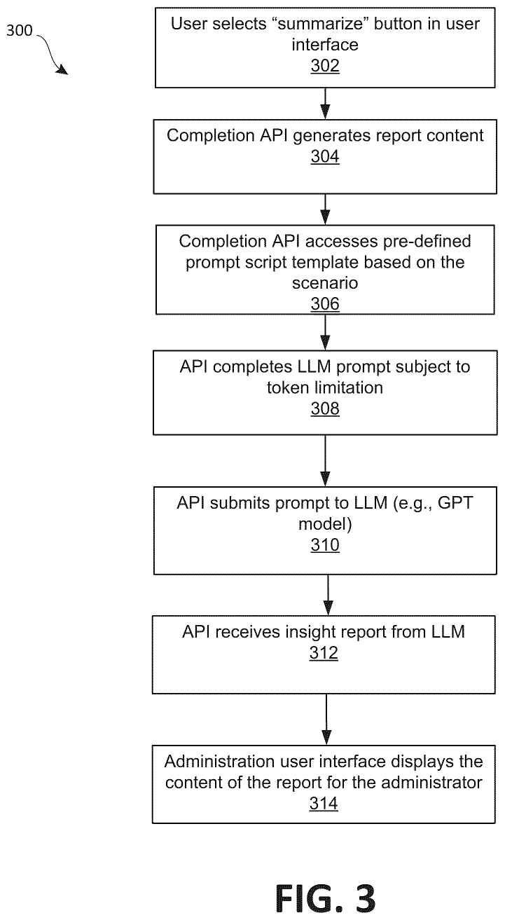

FIG. 3 depicts a flow chart for a method 300 for generating specific insights from a quantity of administrative data according to the principles described herein. As shown in FIG. 3 and as described above, the administrator or user first selects the button 302 to invoke the AI assistant features of the collaboration system. In response to user actuation of this button, the completion API generates the content 304 of all the activity reports corresponding to the category or categories of user activity selected.

The completion API then accesses a pre-defined prompt script or template 306. A number of different prompt scripts or templates may be prepared for different possible scenarios. The completion API then completes the prompt to the LLM 308 using the report or activity data. An LLM may have a limitation on the amount of data that can be included in a single prompt. This is referred to as a token limit because the LLM converts prompt input into a token form for processing. Consequently, the completion API may need to observe a token limit on the amount of activity data appended into a single prompt.

When there is more data than can be included in a single prompt due to the token limit, the API may generate multiple prompts to accommodate all the user activity data. In this case, the response received by the administrator may include multiple pages, each corresponding to the data provided in a single prompt. The administrator can then page through the response. Alternatively, the results from multiple prompts can be combined into a new prompt that returns a summary of all the underlying summaries for the total volume of user activity data.

Next, the API submits the prompt to the LLM 310, as described above. In various examples, the LLM may be a GPT model. The API then receives the corresponding insight report back from the LLM 312. Then, the administrator user interface displays the content of the report for the administrator 314.

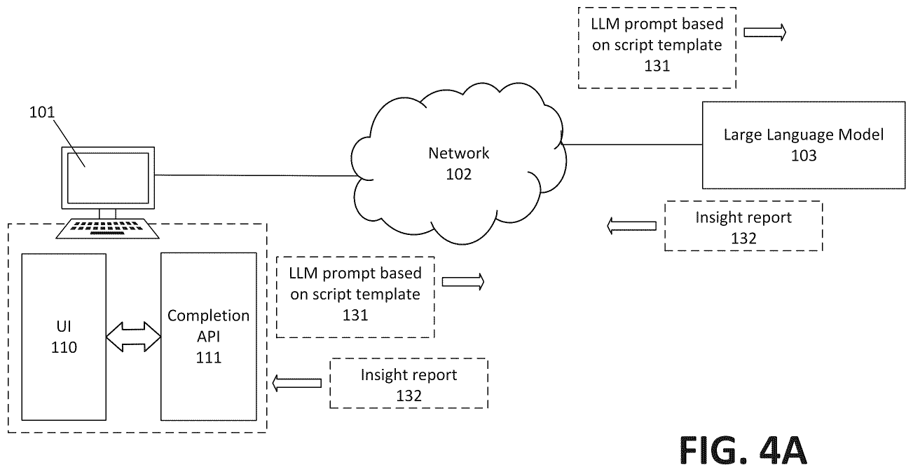

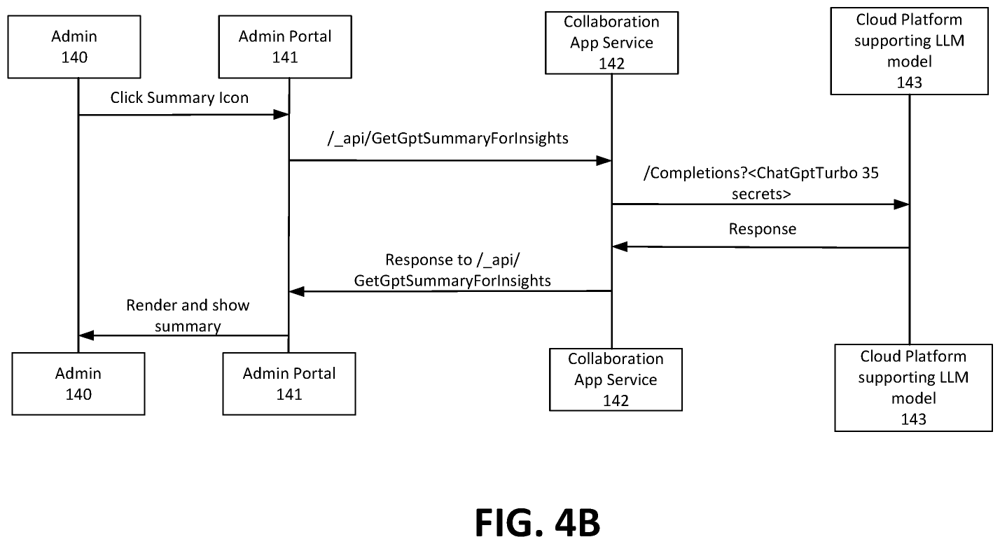

FIG. 4A depicts another example system for generating specific insights from a quantity of administrative data according to the principles described herein. As shown in FIG. 4A, the user terminal 101 operates with the user interface 110 and the completion API 111, as described above. When invoked, the completion API produces and transmits an LLM prompt 131 that is based on a script or template.

The following describes an example of the script or template 112 and its use for engineering the LLM prompt 131. None of the elements of the script or template 112 as described here is required, and these elements can be arranged in a different order. However, this example will illustrate an instance of prompt engineering according to the present disclosure.

First, the prompt 131 may define the system role of the LLM. For the scenarios being addressed in which an administrator needs a digest of voluminous activity data, the script or template 112 may include a statement such as: “You are an AI assistant that helps administrators to manage a collaboration system including collaboration or sharing sites and other resources efficiently.”

Next, the prompt 131 may advise the LLM of the source of the data and explain the scenario that the data is serving. This may be stated in natural language as part of the prompt 131. For example, the prompt may state what category of activity data is being explored and, based on that category, state what potential concerns might be found in the data and for which the LLM should search. In other words, before generating insights, it is helpful to provide the LLM with the relevant source data and explain the scenario. This will help ensure that the generated insights are relevant to the user's needs.

The prompt 131 may also include specifications regarding the output, such as how much detail to include, the format, what aspects to focus on, etc. To ensure that the insights generated are useful and relevant, it is helpful to specify the output. Again, this includes how much detail is needed, the format, and what to focus on. By doing so, the generated insights will be tailored to the user's needs.

Additionally, to avoid overwhelming the user with unnecessary information, the prompt 131 may include terms that effectively turn off the chatty or verbose nature exhibited by some LLMs. This will ensure that the insights generated are clear and concise, without any unnecessary information. For example, the prompt may include a statement such as: “You will try your best to give the insights without further question.” Preventing the LLM from asking questions about the task of the prompt limits the tendency of some LLMs to attempt to chat with the user or be overly verbose in a response.

Using these principles, an example prompt 131 based on an underlying script or template might read as follows for the scenario of a Collaboration Detail Report.
You are an AI assistant that helps administrators to manage a collaboration system including collaboration or sharing sites and other resources efficiently.
The administrator, aka the user, will provide a set of data. You are going to help them to gain insights from that data.
You will summarize your findings with top recommended actions for the next step.
You will limit your share to the top 3 findings.
You will try your best to give the insights without further question.
You will include 1 or 2 data examples from your analysis for each of the insights. The example is not verbatim copy of the data. You will extract and include these detailed values of siteid, siteurl, username, timestamp, and action.
Administrators want to be alerted by abnormal sharing activities. You will focus on interesting sharing activities in your analysis.
Can you read and analyze the collaboration insights detail reports that contain all users' sharing activities within the organization?
The data format is JSON.
Here is the data that was concatenated from multiple JSON entries:

The prompt would then include the activity data as described above. The API 111 will need to prepare the data for inclusion in the prompt. Specifically, the data provided to the LLM needs to be prepared in a way that is compatible with the model. This includes being aware of the token limit and converting the data into a format like JSON or CSV to string.

Along with a prompt 131, other parameters can be sent to control operation of the LLM. For example, the LLM may have a parameter that dictates how creative or imaginative the LLM is in preparing a response. If this setting is high, the LLM may have a tendency to give more creative, but less realistic responses. This is sometimes referred to as the LLM hallucinating. To avoid and control such hallucination when generating insights from collaboration system user activity, the corresponding parameter may be specified along with the LLM prompt 131. In some LLMs, this parameter is referred to as the temperature. Consequently, the LLM prompt 131 may be accompanied by a temperature setting of about 0.2 and no more than 0.4. This will ensure that the generated insights are accurate and relevant.

As further shown in FIG. 4A, the LLM prompt 131 and any associated additional parameters, are sent via the network 102 to the LLM 103. The LLM 103 will operate according to its training on the prompt 131 and produce an insight report 132. The insight report 132 is returned to the user terminal 101 via the network 102. The user interface 110 provides access and display of the insight report 132 to the administrator.

FIG. 4B is an alternative depiction of an example system for generating specific insights from a quantity of administrative data according to the principles described herein. As shown in FIG. 4B, the workflow can be represented between four entities. Beginning with the administrator 140, as described above, the administrator 140 selects a summary icon or similarly labeled button to initiate the AI assistant. This invokes an administrator portal 141 and the API configured to obtain an LLM or GPT summary for insights based on the activity data of the collaboration system. An online or cloud-based service 142 of the collaboration application provides the prompt to a cloud platform 143 that hosts the LLM.

The LLM then processes the prompt, as described above, and returns a response. This response is communicated through the collaboration application service 142 to the administrator portal 141. There, the response is rendered and available to the administrator 140.

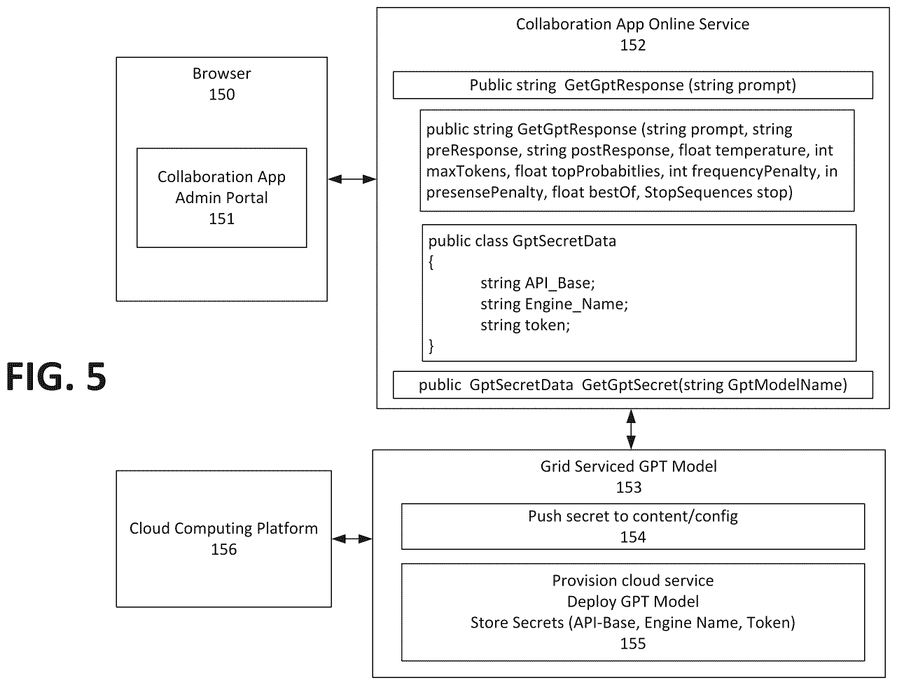

FIG. 5 is an alternative depiction of an example system for generating specific insights from a quantity of administrative data according to the principles described herein. As shown in FIG. 5, the administrator may be using a browser 150 on the user terminal to access the collaboration application administrator portal 151. As described above, this provides communication with the collaboration application online service 152.

In this specific example, the collaboration application online service 152 communicates the prompt for insights to a grid service 153 that operates a cloud computing platform 156. The grid service 153 may have security features 154 to protect the security of the data. The grid service 153 will also include a cloud provisioning service 153 to deploy or utilize a GPT model on the cloud computing platform 156. The grid service 153 thus securely handles the prompt to the GPT model and the response from the GPT model back to the browser 150 of the administrator.

With regard to security, each service resource can have two API keys to enable secret rotation. This security precaution allows the system to regularly change the key that can access the service, thereby protecting the privacy of the resource if a key is compromised. Keys can be rotated manually or automatically on a fixed schedule.

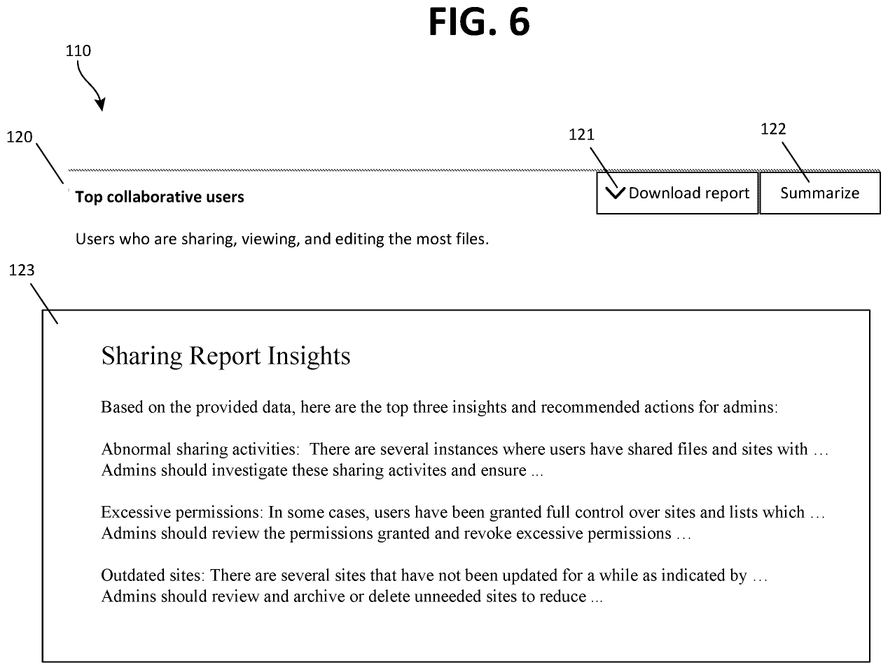

FIG. 6 depicts additional aspects of the user interface of FIG. 2. As shown in FIG. 6, the user interface 110 can receive and display the response 123 from the LLM to the prompt. In the specific example of FIG. 6, such a response or insight report 123 may read as follows:

### Sharing Report Insights

Based on the provided data, here are the top three insights and recommended actions for admins:
Abnormal sharing activities: There are several instances where users have shared files and sites with
Admins should investigate these sharing activities and ensure . . .
Excessive permissions: In some cases, users have been granted full control over sites and lists which
Admins should review the permissions granted and revoke excessive permissions
Outdated sites: There are several sites that have not been updated for a while as indicated by . . .
Admins should review and archive or delete unneeded sites to reduce . . .

In this example, the LLM has prepared the report according to hypothetical instructions similar to those described above in the example prompt. Specifically, the LLM has listed three insights that arise from the volume of underlying user activity data. These insights are directed to interesting or unusual activity patterns that the administrator may want to address. The report would include examples of the issues noted, if requested in the prompt. The report also provides recommendations of action the administrator may want to take to address the activity noted.

In this way, an unmanageable volume of user activity data is processed into concise and meaningful insights with corresponding actions to be considered. As a result, the collaboration system itself can be better administered to provide more secure and efficient operation.

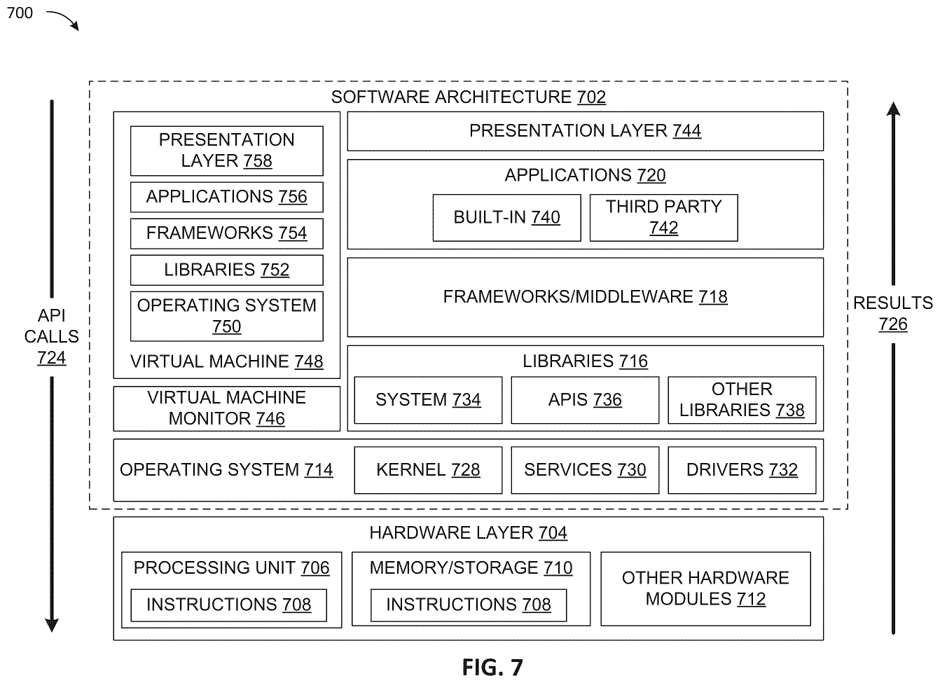

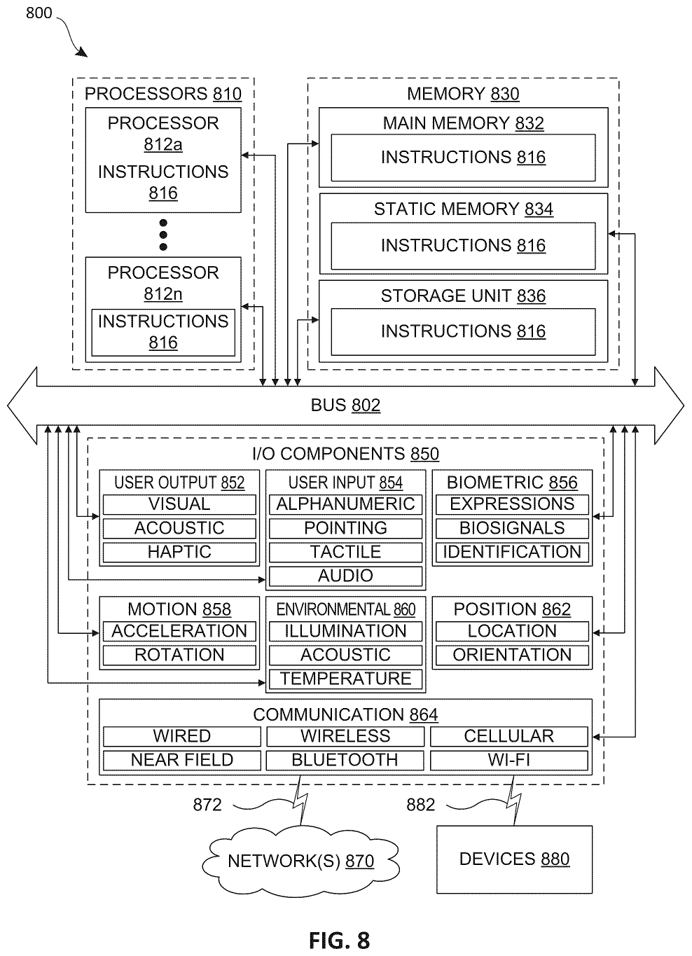

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A device comprising
a processor, and
a memory storing executable instructions which, when executed by the processor, causes the processor, alone or in combination with other processors, to provide the following:
a user interface comprising administrator access to a collaboration system, the user interface comprising a control to invoke an artificial intelligence (AI) assistant function; and
an Application Programming Interface (API) to, in response to activation of the control,
   download user activity data for the collaboration system,
   generate a prompt for a Large Language Model (LLM), the prompt comprising
   the user activity data and instructing the LLM to generate a report based on the user activity data, and
   submit the prompt to the LLM and receive the report generated by the LLM;
wherein the user interface provides the report and controls for administrative actions suggested by the report.
   Item 2. The device of Item 1, further comprising a prompt template for the prompt to the LLM, wherein the API is to access the prompt template to generate the prompt for the LLM.
   Item 3. The device of Item 2, wherein the prompt template includes a statement to define a role for the LLM in generating the report.
   Item 4. The device of Item 2, wherein the prompt template includes a statement specifying a source of the user activity data and a scenario corresponding to the user activity data.
   Item 5. The device of Item 2, wherein the prompt template includes a statement to define at least one of a level of detail, a format and a focus for the report.
   Item 6. The device of Item 2, wherein the prompt template includes a statement to limit questions by the LLM in any response from the LLM.
   Item 7. The device of Item 1, wherein the API includes a setting with the prompt to limit hallucination of the LLM.
   Item 8. The device of Item 1, wherein the LLM is a Generative Pretrained Transformer (GPT).
   Item 9. The device of Item 1, wherein the user interface references the user activity data by different categories.
   Item 10. The device of Item 1, wherein the API uses rotating keys for security.
   Item 11. The device of Item 1, wherein the user interface comprises a browser.
   Item 12. A method of administering a collaboration system, the method comprising:
in response to activation of a control to invoke an artificial intelligence (AI) assistant function in an administrator portal of the collaboration system, downloading a volume of user activity data for the collaboration system;
with an Application Programming Interface (API) generating a prompt for a Large Language Model (LLM), the prompt comprising the user activity data and instructing the LLM to generate a report based on the user activity data; and
submitting the prompt to the LLM and receiving the report generated by the LLM,
wherein the report summarizes insights based on the volume of user activity data and recommended administrative actions corresponding to the insights, the administrator portal providing controls for the administrative actions recommended by the report.
   Item 13. The method of Item 12, further comprising using a prompt template to engineer the prompt to the LLM.
   Item 14. The method of Item 13, wherein the prompt template includes a statement to define a role for the LLM in generating the report.
   Item 15. The method of Item 13, wherein the prompt template includes a statement specifying a source of the user activity data and a scenario corresponding to the user activity data.
   Item 16. The method of Item 13, wherein the prompt template includes a statement to define at least one of a level of detail, a format and a focus for the report.
   Item 17. The method of Item 13, wherein the prompt template includes a statement to limit questions by the LLM in any response from the LLM.
   Item 18. The method of Item 12, further comprising including a setting with the prompt to limit hallucination of the LLM.
   Item 19. The method of Item 12, further comprising rotating API keys for security.
   Item 20. A device comprising:
a processor, and
a memory storing executable instructions which, when executed by the processor, causes the processor, alone or in combination with other processors, to perform the following functions:
download a volume of user activity data for a collaboration system;
with an Application Programming Interface (API), generate a prompt for a Large Language Model (LLM) comprising the user activity data and instructing the LLM to generate a report based on the user activity data; and
submit the prompt to the LLM and receive the report generated by the LLM;
wherein the report summarizes insights based on the volume of user activity data and recommended administrative actions corresponding to the insights, the administrator portal providing controls for the administrative actions recommended by the report.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A device comprising
a processor, and
a memory storing executable instructions which, when executed by the processor, causes the processor, alone or in combination with other processors, to provide the following:
a user interface comprising administrator access to a collaboration system, the user interface comprising a control to invoke an artificial intelligence (AI) assistant function; and
an Application Programming Interface (API) to, in response to activation of the control,
download user activity data for the collaboration system,
generate a prompt for a Large Language Model (LLM), the prompt comprising
the user activity data and instructing the LLM to generate a report based on the user activity data, and
submit the prompt to the LLM and receive the report generated by the LLM;
wherein the user interface provides the report and controls for administrative actions suggested by the report.

2. The device of claim 1, further comprising a prompt template for the prompt to the LLM, wherein the API is to access the prompt template to generate the prompt for the LLM.

3. The device of claim 2, wherein the prompt template includes a statement to define a role for the LLM in generating the report.

4. The device of claim 2, wherein the prompt template includes a statement specifying a source of the user activity data and a scenario corresponding to the user activity data.

5. The device of claim 2, wherein the prompt template includes a statement to define at least one of a level of detail, a format and a focus for the report.

6. The device of claim 2, wherein the prompt template includes a statement to limit questions by the LLM in any response from the LLM.

7. The device of claim 1, wherein the API includes a setting with the prompt to limit hallucination of the LLM.

8. The device of claim 1, wherein the LLM is a Generative Pretrained Transformer (GPT).

9. The device of claim 1, wherein the user interface references the user activity data by different categories.

10. The device of claim 1, wherein the API uses rotating keys for security.

11. The device of claim 1, wherein the user interface comprises a browser.

12. A method of administering a collaboration system, the method comprising:
in response to activation of a control to invoke an artificial intelligence (AI) assistant function in an administrator portal of the collaboration system, downloading a volume of user activity data for the collaboration system;
with an Application Programming Interface (API) generating a prompt for a Large Language Model (LLM), the prompt comprising the user activity data and instructing the LLM to generate a report based on the user activity data; and
submitting the prompt to the LLM and receiving the report generated by the LLM,
wherein the report summarizes insights based on the volume of user activity data and recommended administrative actions corresponding to the insights, the administrator portal providing controls for the administrative actions recommended by the report.

13. The method of claim 12, further comprising using a prompt template to engineer the prompt to the LLM.

14. The method of claim 13, wherein the prompt template includes a statement to define a role for the LLM in generating the report.

15. The method of claim 13, wherein the prompt template includes a statement specifying a source of the user activity data and a scenario corresponding to the user activity data.

16. The method of claim 13, wherein the prompt template includes a statement to define at least one of a level of detail, a format and a focus for the report.

17. The method of claim 13, wherein the prompt template includes a statement to limit questions by the LLM in any response from the LLM.

18. The method of claim 12, further comprising including a setting with the prompt to limit hallucination of the LLM.

19. The method of claim 12, further comprising rotating API keys for security.

20. A device comprising:
a processor, and
a memory storing executable instructions which, when executed by the processor, causes the processor, alone or in combination with other processors, to perform the following functions:
download a volume of user activity data for a collaboration system;
with an Application Programming Interface (API), generate a prompt for a Large Language Model (LLM) comprising the user activity data and instructing the LLM to generate a report based on the user activity data; and
submit the prompt to the LLM and receive the report generated by the LLM;
wherein the report summarizes insights based on the volume of user activity data and recommended administrative actions corresponding to the insights, the administrator portal providing controls for the administrative actions recommended by the report.
